(19) United States
(12) Patent Application Publication
(10) Pub. No.: US 2022/0193778 A1
(43) Pub. Date: Jun. 23, 2022

(54) RESTRAINING OBJECTS

(71) Applicant: HEWLETT-PACKARD DEVELOPMENT COMPANY, L.P., Spring, TX (US)

(72) Inventors: Jorge DIOSDADO BORREGO, Sant Cugat del Valles (ES); Sergio MIGUELEZ CAMPILLO, Sant Cugat del Valles (ES); David CHANCLON FERNANDEZ, Sant Cugat del Valles (ES)

(21) Appl. No.: 17/604,905

(22) PCT Filed: Oct. 9, 2019
(86) PCT No.: PCT/US2019/055313

§ 371 Date: Oct. 19, 2021

(51) Int. Cl. B22F 10/68; B22F 12/00; B33Y 10/00; B33Y 40/20; B33Y 30/00

(52) U.S. Cl. CPC B22F 10/68; B22F 12/00; B22F 10/28; B33Y 40/20; B33Y 30/00; B33Y 10/00

(57) ABSTRACT

According to one example, there is provided apparatus for restraining objects during a powder and object separation process. The apparatus comprises a base plate comprising a set of spatially arranged apertures, a set of rods, each rod slidable within a corresponding aperture of the base plate. The base plate is to connect with a chamber to contain a volume of powder and objects to be separated and the apparatus is configured such that, when the apparatus is connected to a chamber containing a volume of powder and 3D objects the set of rods are positionable in, or are slideable into, a position extending vertically away from the chamber, and as powder is removed from under each rod, the rods are to slide through the apertures.

### BACKGROUND

There exist a multitude of kinds of three-dimensional (3D) printing techniques that allow the generation of 3D objects through selective solidification of a build material based on a 3D object model.

Powder-based 3D printing techniques typically involve forming successive layers of a powdered or granular build material on a build platform in a build chamber, and selectively solidifying portions of each layer to form each layer of the 3D object. Some 3D printing systems selectively apply curable binder agent to each layer of powder to selectively solidify portions of each layer. Other 3D printing systems selectively apply an energy absorbing fusing and then apply fusing energy to each layer. Other 3D printing systems use a laser to selectively solidify portions of each layer.

### BRIEF DESCRIPTION

Examples will now be described, by way of non-limiting example only, with reference to the accompanying drawings, in which:

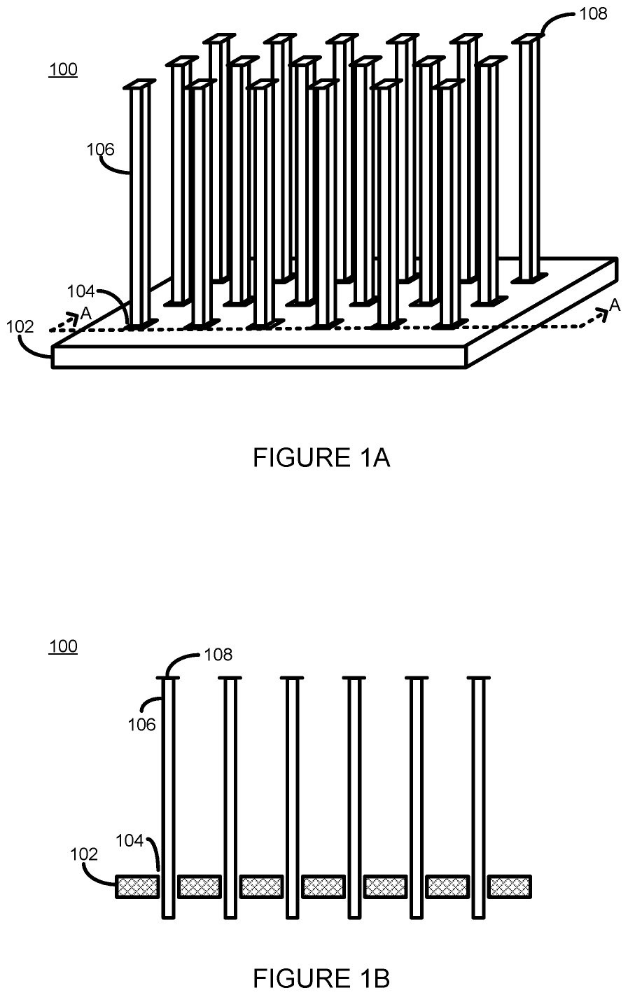

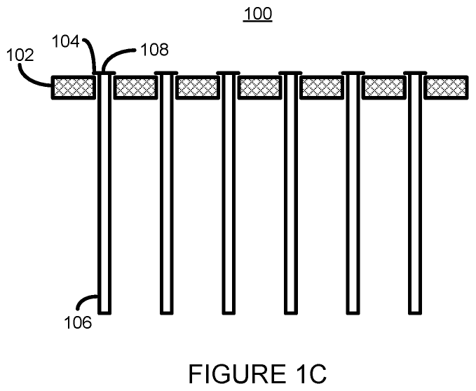

FIGS. 1A, 1B, and 1C illustrate an apparatus according to one example;

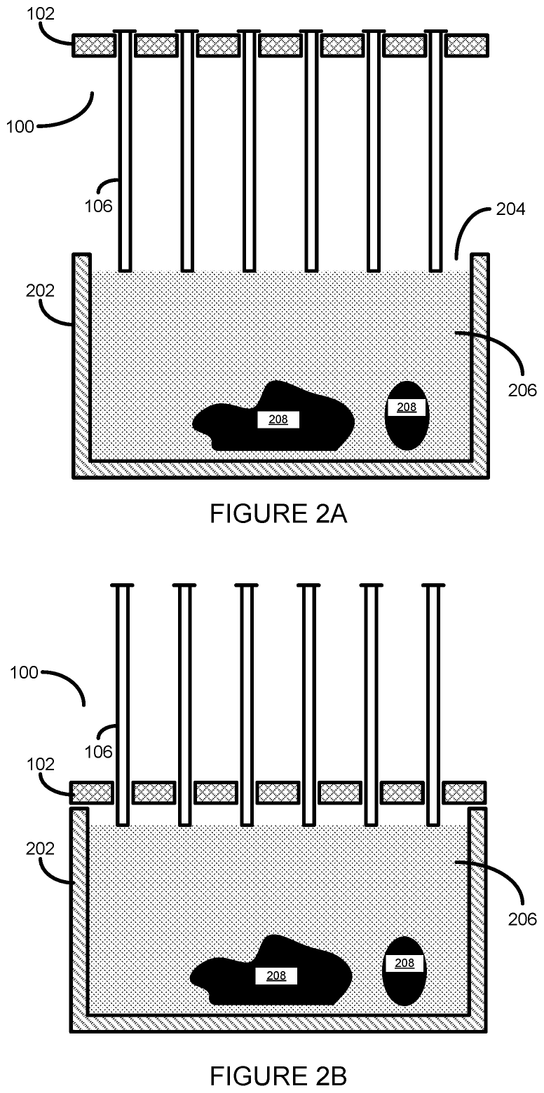

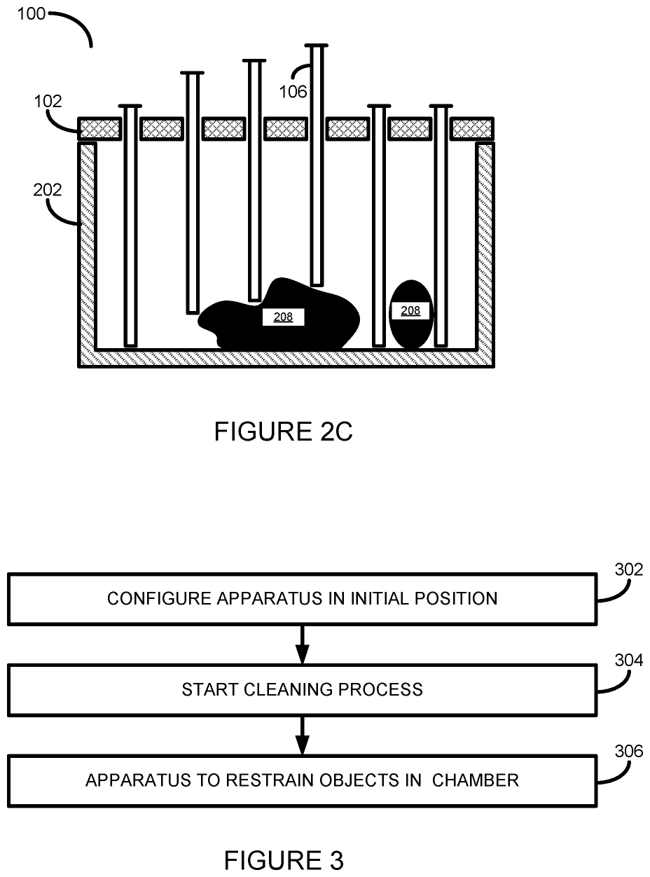

FIG. 2A, 2B, 2C illustrate use of an apparatus with a chamber according to one example;

FIG. 3 is flow diagram outlining an example method of operating an apparatus according to one example;

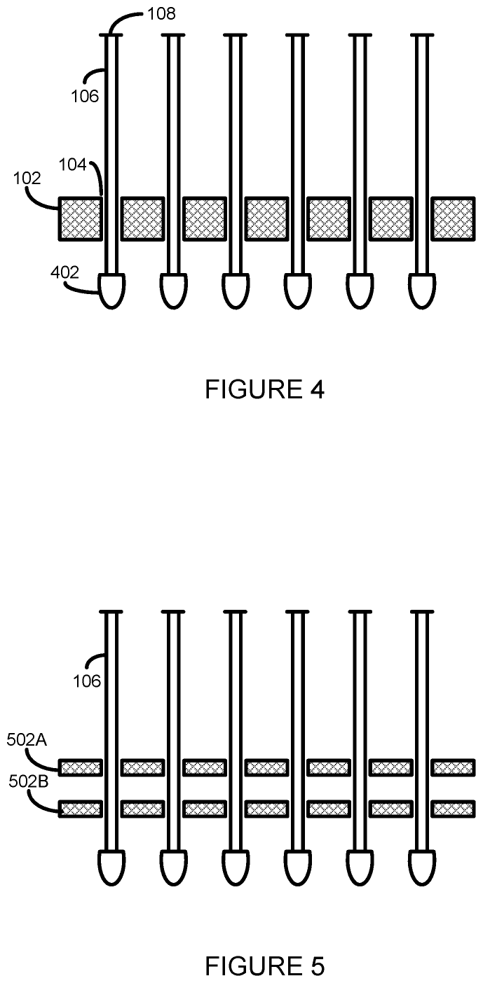

FIG. 4 illustrates an apparatus according to one example;

FIG. 5 illustrates an apparatus according to one example;

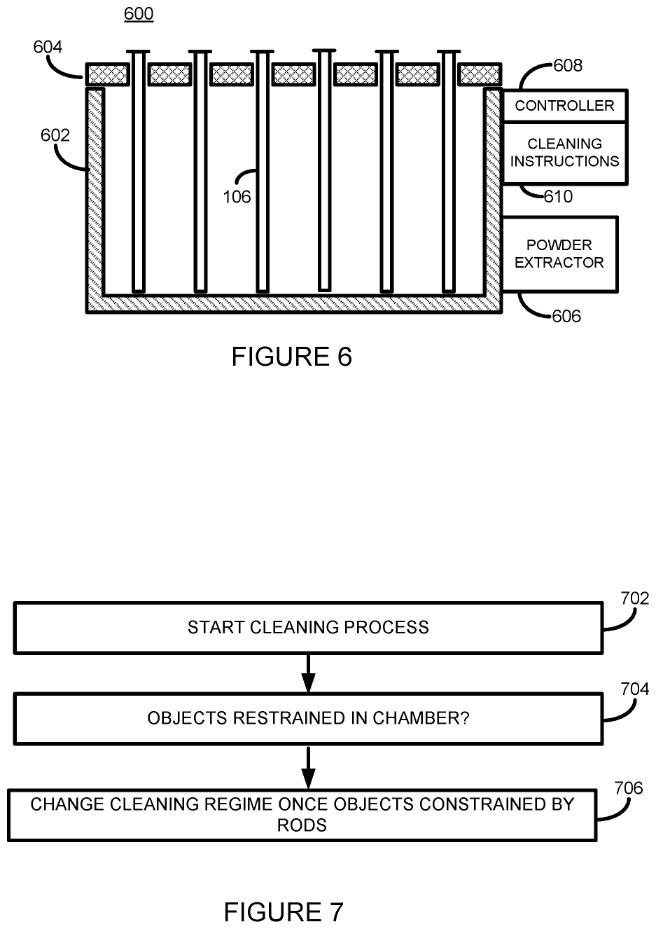

FIG. 6 illustrates an apparatus according to one example; and

FIG. 7 is flow diagram outlining an example method of operating an apparatus according to one example.

### DETAILED DESCRIPTION

After completion of a 3D print job, a 3D build chamber comprises a set of 3D objects, formed through solidification of powder, and a surrounding volume of non-solidified powder. To allow the objects to be removed from the build chamber the non-solidified powder and the 3D objects have to be separated. Ideally, the separation process should also substantially clean (i.e. remove a high level of powder from the surface) of the 3D objects.

Depending on the 3D printing technique used, the generated 3D objects may have varying strengths. For example, 3D objects formed using a laser (e.g. laser sintering) or using a fusing agent and fusing energy will generally have a high strength. However, such objects may comprise relatively fragile features. 3D objects formed using a curable binder agent, however, may have a relatively weak strength. For example, a curable binder may form a relatively weakly bound matrix of powder particles, such as metal or ceramic powder particles, referred to generally as a green part. Green parts have to be sintered, for example in a sintering furnace, for the powder particles to sinter or fuse together to form a final highly dense and strong 3D object.

Efficient cleaning (i.e. removal of non-solidified powder) of 3D objects is an important but challenging process in a 3D printing workflow, as the aim is generally to remove as much possible non-solidified powder from the 3D objects in an automated manner, whilst not damaging the objects. However, in order to remove a high percentage of non-solidified powder, cleaning techniques such as high-speed air flows, vacuum airflows, and vibration are used, which can cause damage to objects or portions of objects.

Referring now to FIGS. 1A and 1B, there is shown an apparatus 100 for use with a cleaning chamber. FIG. 1A shows a simplified isometric view of the apparatus 100 according to one example, and FIG. 1B shows a simplified cross section of the apparatus 100 through the plane A:A.

The apparatus 100 comprises a rigid base plate 102, for example made of sheet metal such as aluminum or steel, having a plurality of apertures 104 formed therein. In the example shown the apertures 104 are arranged in a regular grid configuration, although in other examples other patterns of apertures 104 may be used.

Within each aperture 104 is provided a slidable rod 106. Each rod 106 may be made from a rigid or relatively rigid material, such as a suitable metal or plastic. In the example shown each aperture 104 has a square cross-section, and each rod 106 has a corresponding cross-section. In other examples, the apertures 104 and rods 106 may have any suitable cross-section, such as a circular, an oval, a polygon. The cross-section of each rod 106 is slightly smaller than the cross-section of each aperture 104 to allow each rod to be generally freely slidable, at least when the base plate 102 is in a generally horizontal orientation. In one example, each aperture 104 may be surrounded by a low-friction bush, or may be treated, with a low-friction coating, to assist each rod 106 to slide through the base plate 102. Additionally, or alternatively, each rod 106 may be made of or may be coated with a relatively low-friction material, such as Teflon™. Each rod 106 may have a weight that enables it slide through its associated aperture 104 under gravity when the base plate 102 is in a substantially horizontal orientation, with the force of gravity being sufficient to overcome any frictional forces between each rod and its associated aperture.

In the example shown, the upper portion of each rod 106 has a retention portion 108 that has a cross-section or a shape to prevent each rod from sliding completely through the base plate 102 when the base plate is in a substantially horizontal orientation. In some examples a retention portion 108 may be provided on the lower end of each rod, in addition to the retention portion on the upper portion of each rod.

FIG. 1C illustrates the apparatus 100 when each of the rods 106 has slid, under gravity, through their respective apertures. As shown in FIG. 1C, the rods 106 are prevent from sliding completely through the base plate 102 by their retention portions 108.

The use of the apparatus 100 during the process of separating 3D printed objects and powder from a chamber will now be described, with reference to FIGS. 2A, 2B, and 2C.

In FIG. 2A, a chamber 202, such as a 3D printing build chamber or a chamber external to a 3D printer to which the contents of a 3D printing build chamber have been transferred, is provided. In the example shown, the chamber 202 contains a volume 204 of non-solidified powder 206 and one or multiple 3D printed objects 208. The chamber 202 may have an associated powder and 3D object separation mechanism (not shown) that may include one or more of:
a. an air outlet to allow air and non-solidified powder to be pneumatically extracted from the chamber;
b. an air inlet to allow high speed air to be introduced into the chamber to help separate non-solidified powder from 3D objects;
c. a powder extraction port to allow non-solidified to be extracted from the chamber, for example, under gravity; and
d. a mechanical actuator, such as a vibrator or ultrasonic transducer, to mechanically assist the separation of non-solidified powder and 3D printed objects.

In FIG. 2A, the apparatus 100 is positioned above the chamber 202 such that the rods 106 are positioned at their lowest position relative to the base plate 102. The apparatus 100 is then lowered over the chamber, as illustrated in FIG. 2B, such that the base plate 102 engages with the top of the chamber sidewalls. As the apparatus 100 is lowered, the lower ends of the rods 106 push against the volume of non-solidified powder 206 and slide upwards relative to the base plate 102, as illustrated in FIG. 2B. At this point, the base plate 102 may be suitable secured, for example using a connection mechanism, to the chamber 202. In one example, when the base plate 102 is secured to the chamber 202 the base plate 102 provides a substantially hermetic seal to the chamber 202, thereby preventing powder in the chamber 202 from escaping during a cleaning operation.

An outline method of operating the apparatus 100 according to one example will now be described, with additional reference to FIG. 3.

At block 302 the apparatus 100 is configured in a starting configuration, for example where it is securely engaged to a chamber 202 comprising a volume of non-solidified powder 206 and 3D printed objects 208, for example as shown in FIG. 2B.

At block 304, a cleaning, or non-solidified powder and 3D object separation, process is started thereby removing non-solidified powder from the chamber 202. As non-solidified powder is removed from the chamber, the rods 106 slide down under gravity through the base plate 102 as the powder supporting them is removed. When most or all of the non-solidified build material has been removed from the chamber 202, each rod will be either at its lowest position relative to the base plate 102, or will be resting on a 3D printed object, as illustrated in FIG. 2C. Depending on the nature of any 3D printed objects in the chamber 202, and depending on the number and configuration of rods 106 in the apparatus 100, each of the 3D objects will be restrained (block 306) by one or more of the rods 106. In one example, the apparatus 100 comprises a base plate having dimensions of 30 cm by 40 cm, and has a set of rods arranged in a 10 by 10 grid configuration. In another example, apparatus may be configured to have a rod grid configuration having rods spaced apart by about 1 cm, or by about 2 cm, or by about 3 cm, or by about 5 cm, or by about 10 cm.

For example, some objects may be restrained between an internal wall of the chamber 202 and at least one rod 106, some objects may be restrained between two or more rods 106, some objects may be restrained by one or more rods resting on the surface of an object, and some objects may be restrained in a combination of manners. Depending on the nature of the objects and the configuration of the rods 106 and base plate 102 a restrained object be either substantially prevented from moving, for example by moving laterally, or may have its degree of freedom to more reduced by the rods 106.

In this way, during a powder and 3D object separation process, the rods 106 automatically descend as non-solidified powder is removed from under them to restrain the objects. Restraining objects in this manner prevents or substantially reduces the likelihood of objects being damaged by, for example, colliding with another object, colliding with an internal chamber sidewall, or the like. Without the apparatus 100, if strong airflows are used to separate non-solidified powder from 3D objects, these airflows can cause 3D printed objects to move within the chamber and collide with each other or with internal chamber walls, particularly if the airflows are turbulent airflows. Similarly, if mechanical actuation, such as vibration or shaking, is used during the separation, this can also cause non-restrained objects to move around within the chamber and become damaged.

The cleaning process may, for example, be continued for a predetermined time during which the objects 208 within the chamber are restrained and are prevented from being damaged through collisions with other objects or the internal side walls of the chamber 202. The apparatus 102 thereby allows the cleaning process to be performed for longer than would be possible without use of the apparatus, and also allows the cleaning process to use stronger cleaning techniques, such as higher airflows and more energetic vibration of the chamber. The apparatus 102 thus allows for a more thorough cleaning process than is possible without use of the apparatus 102.

In FIG. 4 is shown a further example of the apparatus 102. In this example, the lower end of at least some of the rods 106 are provided with a compliant portion 402. The compliant portion 402 may be formed, for example, from a suitable relatively soft and compliant material, such as silicone, rubber, foam, or the like. The compliant portion 402 is to further reduce the likelihood of a 3D object being damaged from contact with the lower end of a rod 106. In one example, the compliant portion 402 is weighted, i.e. has a higher density than the rest of the rod body 106. A rod weighted in this way may, for example, slide more easily through the base plate 102 and may restrain objects in a more secure manner.

In FIG. 5 is shown a further example of the cleaning apparatus 102 in which a two spatially separated base plates 502A and 502B are provided. In one example, the base plates may be spaced apart by about 1 cm, or by about 2 cm, or by about 3 cm, or by about 5 cm, or by about 10 cm. Spaced apart base plates 502 may ensure better vertical stability of the rods 106. This may, for example, reduce the amount of lateral movements of the rods 106 during a cleaning operation, which may further help reduce damage from occurring to 3D printed objects being restrained by the rods 106.

Referring now to FIG. 6, there is shown an integrated cleaning system 600 according to one example. The cleaning system comprises a chamber 602 to contain a volume of non-solidified powder and 3D printed objects, and an object restraining mechanism 604, such as the apparatus 100. In one example the cleaning system 600 may be integrated into a 3D printing system, such as a 3D printer, in which case the chamber 602 may be a 3D printing build chamber. In one example, the object restraining mechanism 604 is removably attachable to the chamber 602.

The system 600 comprises a schematically shown powder extractor 606 coupled to or integrated with the chamber 602. The powder extractor 606 may comprise one or more of:
a. a vacuum source to generate an extraction airflow;
b. an air outlet to allow the extraction airflow to pneumatically extract non-solidified powder from the chamber 602;
c. an air flow source, such as a fan or a compressor;
d. an air inlet, or a set of air inlets, to allow high speed air generated by the air source to be introduced into the chamber 602 to help separate non-solidified powder from 3D objects;
e. a powder extraction port in the base of the chamber 602 to allow non-solidified to be extracted from the chamber at least partially under gravity; and
f. a mechanical actuator, such as a vibrator or ultrasonic transducer, to mechanically assist the separation of non-solidified powder and 3D printed objects, for example by vibrating or shaking at least part of the chamber 602.

The system 600 additionally comprises a controller 608, such as a microprocessor, to control the powder extractor 606. The controller 608 is coupled to a memory in which are stored machine-readable cleaning instructions 610. The instructions 610, when executed by the controller 608 cause the controller 608 to operate the system 600 as described below with additional reference to the flow diagram of FIG. 7.

At block 702, the controller 608 controls the powder extractor 606 to start the cleaning process. In this example, the controller 608 controls the powder extractor 606 to operate according to a first cleaning scheme. For example, the first cleaning scheme may initially use only relatively low inlet and extraction air flows and may use either no vibration or only relatively low amplitude vibrations to extract a first portion of non-solidified powder from the chamber 602 in a relatively gentle manner. In another example, the first cleaning scheme may initially use only vibration from the mechanical actuator to extract a first portion of non-solidified powder from the chamber 602 in a relative gentle manner, and may use no or relatively low power inlet and extraction airflows. As powder is removed from the chamber 602 the retaining rods 106 start to slide down to restrain 3D printed objects within the chamber.

In one example, the controller operates the first cleaning scheme for a predetermined length of time, for example based on factors that may include the size of the chamber 602 and the flowability of the non-solidified powder. In another example, the system 600 additionally comprises at least one sensor to detect, for example, when the level of non-solidified powder in the chamber 602 has fallen below a predetermined level, or to detect when one or more of the rods 106 have reached a stable position indicating that the rod is either at its lowest position or is resting on a 3D printed object. In this way, the controller can detect, either directly or indirectly, that 3D printed objects in the chamber 602 are being restrained (block 704).

At block 706, the controller 608 controls the powder extractor 606 to operate according to a second cleaning scheme. The second cleaning scheme may a relative stronger cleaning scheme that the first cleaning scheme. For example, when operating according to the second cleaning scheme, the powder extractor 606 may create stronger inlet and extraction airflows and may use more powerful vibrations than used during the first cleaning scheme.

In this way, the first cleaning scheme is used to remove sufficient non-solidified powder to allow the rods 106 to restrain any 3D printed objects within the chamber 602, and then a second more powerful cleaning scheme is used to increase the cleaning efficiency of the system 600 whilst at the same time preventing or mitigating damage to objects in the chamber 602.

It will be appreciated that example described herein can be realized in the form of hardware, software or a combination of hardware and software. Any such software may be stored in the form of volatile or non-volatile storage such as, for example, a storage device like a ROM, whether erasable or rewritable or not, or in the form of memory such as, for example, RAM, memory chips, device or integrated circuits or on an optically or magnetically readable medium such as, for example, a CD, DVD, magnetic disk or magnetic tape. It will be appreciated that the storage devices and storage media are examples of machine-readable storage that are suitable for storing a program or programs that, when executed, implement examples described herein. Accordingly, some examples provide a program comprising code for implementing a system or method as claimed in any preceding claim and a machine-readable storage storing such a program.

All of the features disclosed in this specification (including any accompanying claims, abstract and drawings), and/or all of the steps of any method or process so disclosed, may be combined in any combination, except combinations where at least some of such features and/or steps are mutually exclusive.

Each feature disclosed in this specification (including any accompanying claims, abstract and drawings), may be replaced by alternative features serving the same, equivalent or similar purpose, unless expressly stated otherwise. Thus, unless expressly stated otherwise, each feature disclosed is one example only of a generic series of equivalent or similar features.

1. Apparatus for restraining objects during a powder and object separation process, comprising:
a base plate comprising a set of spatially arranged apertures;
a set of rods, each rod slidable within a corresponding aperture of the base plate;
the base plate to connect with a chamber to contain a volume of powder and objects to be separated, the apparatus being configured such that, when the apparatus is connected to a chamber containing a volume of powder and 3D objects the set of rods are positionable in, or are slideable into, a position extending vertically away from the chamber, and as powder is removed from under each rod, the rods are to slide through the apertures.

2. The apparatus of claim 1, wherein the lower ends of at least some of the rods comprise a compliant portion.

3. The apparatus of claim 1, wherein the rods are weighted to allow them to slide through their associated aperture under gravity when the base plate is in a substantially horizontal orientation.

4. The apparatus of claim 1, wherein the upper end of each rod comprises a retention portion to prevent them from completely sliding through the base plate.

5. The apparatus of claim 1, comprising two spatially separated apertured base plates through which each rod is slidable.

6. Apparatus for separating 3D printed objects and powder after a 3D printing operation, the apparatus comprising:
a chamber to contain a volume of powder and 3D objects to be separated from the powder;
a powder removal module to remove powder from the chamber;
an object restraining module positioned in or positionable above the chamber, the object restraining module comprising:
a base plate comprising a set of spatially arranged apertures;
a set of rods, each rod vertically slidable within a corresponding aperture.

7. The apparatus of claim 6, wherein, in an initial position, when the chamber contains a volume of powder and 3D objects to be separated, the rods are positioned at or are positionable in an upper position vertically above the volume of powder and 3D objects, and as powder is removed by the powder removal module, each rod is to slide through its corresponding aperture as powder is removed below it.

8. The apparatus of claim 6, wherein the powder removal module comprises one or more of:
a. a vacuum source to generate an extraction airflow;
b. an air outlet to allow the extraction airflow to pneumatically extract non-solidified powder from the chamber;
c. an air flow source;
d. an air inlet to allow an air flow generated by the air source to be introduced into the chamber to help separate non-solidified powder from 3D objects;
e. a powder extraction port in the base of the chamber to allow non-solidified to be extracted from the chamber at least partially under gravity; and
f. a mechanical actuator to mechanically assist the separation of non-solidified powder and 3D printed objects.

9. The apparatus of claim 8, further comprising a controller to control the powder removal module to extract powder from the chamber according to a first cleaning scheme.

10. The apparatus of claim 9, wherein the controller is to control the powder removal module to operate according to a first cleaning scheme and then to control the powder removal module to operate according to a second cleaning scheme.

11. The apparatus of claim 10, wherein the controller is to control the powder removal module to operate in a relatively gentle manner until it is determined that objects in the chamber are restrained by the rods, and then to control the powder removal module to operate in a relatively stronger manner.

12. The apparatus of claim 8, wherein the controller is to control the powder removal module to extract powder by one or more of:
a) controlling the mechanical actuator to vibrate at least a portion of the chamber;
b) controlling the vacuum source to generate an extraction airflow and controlling the air flow source to generate an airflow to help separate non-solidified powder from objects in the chamber.

13. The apparatus of claim 12, further comprising a sensor to determine when 3D printed objects in the chamber are being restrained.

14. A method of separating 3D printed objects and non-solidified powder after a 3D printing operation, comprising:
engaging an object restraining apparatus to a chamber comprising a volume of non-solidified powder and 3D printed objects;
extracting non-solidified powder from the chamber; and
restraining 3D printed objects in the chamber with the restraining apparatus.

15. The method of claim 14, wherein the restraining apparatus comprises a set of apertures and a slidable rod within each aperture, and wherein as non-solidified powder is extracted from the chamber, the rods slide through the baseplate to restrain 3D objects in the chamber.
